(19) United States
(12) Patent Application Publication
(10) Pub. No.: US 2011/0180366 A1
(43) Pub. Date: Jul. 28, 2011

(54) CLUTCH ASSEMBLY

(75) Inventors: Servet Yildiz, Gensingen (DE); Michael Kiefer, Zornheim (DE); Axel Geiberger, Mainz (DE)

(73) Assignee: GM GLOBAL TECHNOLOGY OPERATIONS LLC, Detroit, MI (US)

(21) Appl. No.: 13/122,164

(22) PCT Filed: Aug. 19, 2009
(86) PCT No.: PCT/EP09/05988

§ 371 Date: Apr. 1, 2011

(30) Foreign Application Priority Data
Oct. 2, 2008 (GB) 0818209.9

(51) Int. Cl. F16D 13/60; B23P 11/00

(52) U.S. Cl. 192/107 R; 29/428

(57) ABSTRACT

A disc component of a clutch assembly includes, but is not limited to, one or more mounting structures. One of the mounting structures opens in a longitudinal direction of the disc component. The mounting structure is configured to receive a pre-mounted fastener on a second disc component of the clutch assembly from the longitudinal direction. The pre-mounted fastener is configured to fasten the disc component to the second component of from a lateral side of the disc component.

### CROSS-REFERENCE TO RELATED APPLICATIONS

This application is a U.S. National-Stage entry under 35 U.S.C. §371 based on International Application No. PCT/EP2009/005988, filed Aug. 19, 2009, which was published under PCT Article 21(2) and which claims priority to British Application No. 0818209.9, filed Oct. 2, 2008, which are all hereby incorporated in their entirety by reference.

### TECHNICAL FIELD

The present invention relates to a clutch assembly for automobiles.

### BACKGROUND

A clutch assembly transmits torque between an engine and a gearbox. The clutch assembly comprises a single clutch or a dual clutch. A single clutch can be engaged to transmit torque between a crankshaft of the engine and an input shaft of the gearbox. Once engaged, the two shafts are connected and spin at the same speed. The single clutch can also be disengaged so that the two shafts are disconnected and spin at different speeds. On the other hand, a dual clutch can be engaged to transmit torque from the crankshaft to one of the two input shafts of the gearbox. There exists a need to make the clutch assembly to be compact and easily accessed inside a closely fitted clutch casing.

### SUMMARY

The present application provides a disc component of a clutch assembly. The disc component comprises one or more structure, the mounting structure that opens in a longitudinal direction of the disc component. The mounting structure is configured to receive a pre-mounted fastener on a second disc component of the clutch assembly from the longitudinal direction. The pre-mounted fastener is configured to fasten the disc component to the second component of from a lateral side of the disc component. The pre-mounted fastener is a partially fastened fastener on the second disc component.

The present application also provides a clutch assembly that comprises one or more openings. The openings are configured to receive one or more pre-mounted fasteners on a disc component of the clutch assembly for fastening the disc component to the clutch assembly from a lateral direction of the clutch assembly. For example, the opening is in the form of a circular hole for receiving a shank of a screw for fastening the screw from a lateral direction of the clutch assembly.

Typically, there are several fasteners evenly distributed around the disc, although sometimes one fastener is sufficient. The clutch assembly has a longitudinal axis, which is also a rotation axis of the clutch assembly. Any direction that is not parallel to the longitudinal axis is considered to be a lateral direction to the clutch assembly. A crankshaft of an engine, the clutch assembly and an input shaft of a gearbox share the rotation axis of the clutch assembly. These parts are also connected in the longitudinal direction of the clutch assembly. The disc component can be any component of the clutch assembly that rotates around the longitudinal axis. For example, the disc component can be a flywheel and clutch device. The clutch device is part of the clutch assembly that comprises a pressure plate, a housing or a cover.

Since the pre-mounted fasteners can be fastened from a lateral side of the clutch assembly, components along the longitudinal axis cause little obstruction for the fastening. There can be more design and maintenance freedom for assembling and disassembling the clutch assembly. The clutch assembly can also be made more compact in the longitudinal direction. Larger fasteners are possible to be used for ensuring a more robust clutch assembly.

The opening on the mounting structure can comprise a lateral slot that opens in a direction parallel to a longitudinal axis of the clutch assembly. The slot permits the fastener to enter the slot in the longitudinal direction of the clutch assembly. In other words, the disc component with pre-mounted fasteners can be attached to the clutch assembly from the longitudinal direction of the clutch assembly. When attached, the fasteners can enter the lateral slots respectively. When the fasteners are pre-mounted, they are less likely to be dropped off during an assembling process. The loosed parts, including fasteners, can be difficulty to capture and may cause failure in an assembled clutch assembly.

A screw is suitable to be used as the pre-mounted fastener for providing a robust clutch assembly. Alternatively, a rivet can be used as the fastener for fast assembling.

In a typical assembling process, a flywheel is firstly attached to a crankshaft of an engine, a clutch device is then attached to the flywheel. The flywheel as a form of the disc component with pre-mounted fasteners can then be attached to the clutch device in the longitudinal direction. Instead of tightening the fasteners from the longitudinal direction, the pre-mounted fasteners can be tightened from a lateral side of the clutch assembly. Larger tools can therefore be used for provide reliable fastening. The disc component can also be in the form of a pressure plate, a housing or any other component of the clutch assembly that rotates around the longitudinal axis. Similar advantages can be obtained.

Once a longitudinal axis of the pre-mounted fastener is in a rotation plane of the clutch assembly, lateral side of the clutch assembly can be fully utilised for fastening the clutch assembly. This is because there is less components around the clutch device laterally. The rotation plane is perpendicular to the longitudinal axis of the clutch assembly.

More advantageously, the longitudinal axis of the pre-mounted fastener can be perpendicular to a direction of central fugal force of the pre-mounted screw when the clutch assembly rotates around the longitudinal axis of the clutch assembly. This arrangement can minimise the effect of the centrifugal force that may loosen the fastener.

The clutch assembly can comprise a casing that is closely fitted to the clutch assembly. The closely fitted casing can further cause difficulty in tightening in the longitudinal direction of the clutch assembly. When the pre-mounted fastener can be fastened from a lateral side of the clutch assembly through openings on the casing, a mechanic has little difficulty in assembling and disassembling the clutch assembly from the lateral side.

A stopper can be provided for the clutch assembly for preventing longitudinal movement of the disc component in the clutch assembly. The stopper can be in the form of a screw that is bolted to the flywheel and pushed against the clutch device. The screw can prevent the flywheel from departing from the clutch device in the longitudinal direction. The stopper can also be in the form of a slot on the flywheel that matches a fin on the clutch device. The stopper can further be embodied in a housing that holds the clutch device and pushes against the flywheel.

The clutch assembly can be in the form of a dual clutch or a single clutch. The clutch assembly can be a part of a power train. In a motor vehicle, the powertrain comprises components that generate power and deliver it to the road surface, water, or air. The power train includes the engine, transmission, drive shafts, differentials, and drive wheels. The clutch device can further be part of an automobile. The power train or the automobile with the clutch assembly is convenient for servicing. The improved clutch assembly also facilitates the exchange and repair of the clutch assembly.

The application provides a method of assembling a clutch assembly. The method comprises the steps of pre-mounting one or more fastener onto a disc component of the clutch assembly. More fasteners are usually provided for the assembling. This is followed by installing the disc component with the pre-mounted fasteners from a longitudinal direction of the clutch assembly. A further step of the method is fastening the pre-mounted fasteners from a lateral side of the clutch assembly. In these steps, there is no requirement for fastening the pre-mounted fasteners from the longitudinal direction of the clutch assembly. A mechanic can have much flexibility and freedom to access, including fastening and loosening, the pre-mounted fasteners.

In other words, according to the application, a method of disassembling a clutch assembly comprises a first step of partially loosening at least one fastener on a disc component of the clutch assembly. A second step of the method is removing the disc component with the partially loosened at least one fastener in a longitudinal direction of the clutch assembly. The disc component can be loosened from a lateral side even when the clutch assembly is not detached from the power train. After the loosening, disassembling the clutch assembly or the power train becomes much easier.

### BRIEF DESCRIPTION OF THE DRAWINGS

The present invention will hereinafter be described in conjunction with the following drawing figures, wherein like numerals denote like elements, and:

FIG. 1 illustrates a side view of an exposed dual clutch;

FIG. 2 illustrates a side view of a cover of the dual clutch;

FIG. 3 illustrates a further dual clutch using pre-mounted cap screws;

FIG. 4 illustrates a longitudinal view of the further dual clutch of FIG. 3;

FIG. 5 illustrates an enlarged portion of the further dual clutch of FIG. 4;

FIG. 6 illustrates a flywheel of the further dual clutch for assembling using pre-mounted cap screws;

FIG. 7 illustrates a pre-mounted socket screw of a further dual clutch in a tightening step; and

FIG. 8 illustrates the tightened pre-mounted socket screw of FIG. 7.

### DETAILED DESCRIPTION

The following detailed description is merely exemplary in nature and is not intended to limit application and uses. Furthermore, there is no intention to be bound by any theory presented in the preceding background or summary or the following detailed description.

In the following description, details are provided to describe the embodiments of the application. It shall be apparent to one skilled in the art, however, that the embodiments may be practiced without such details.

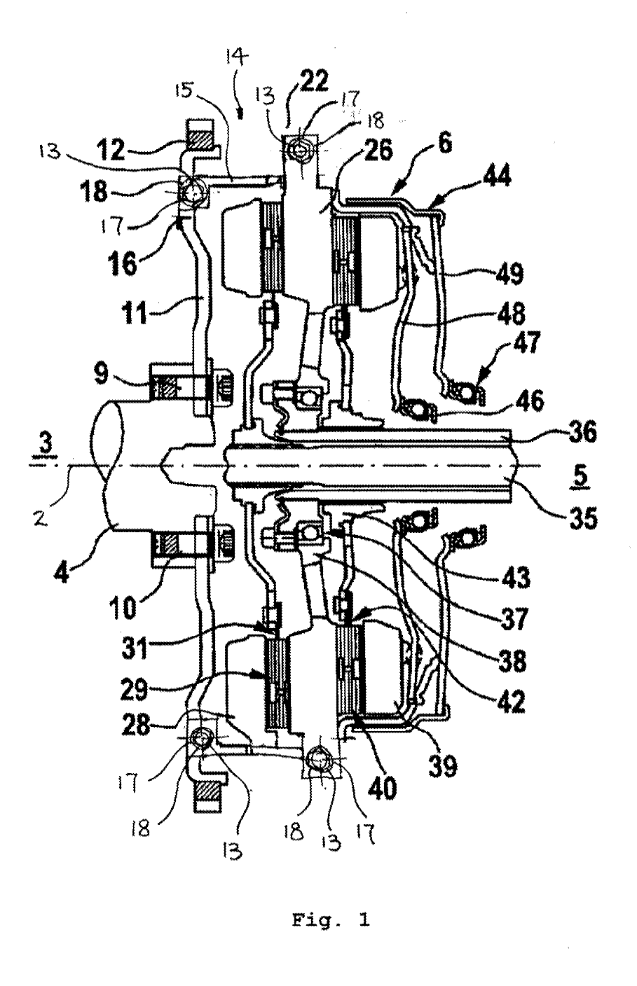

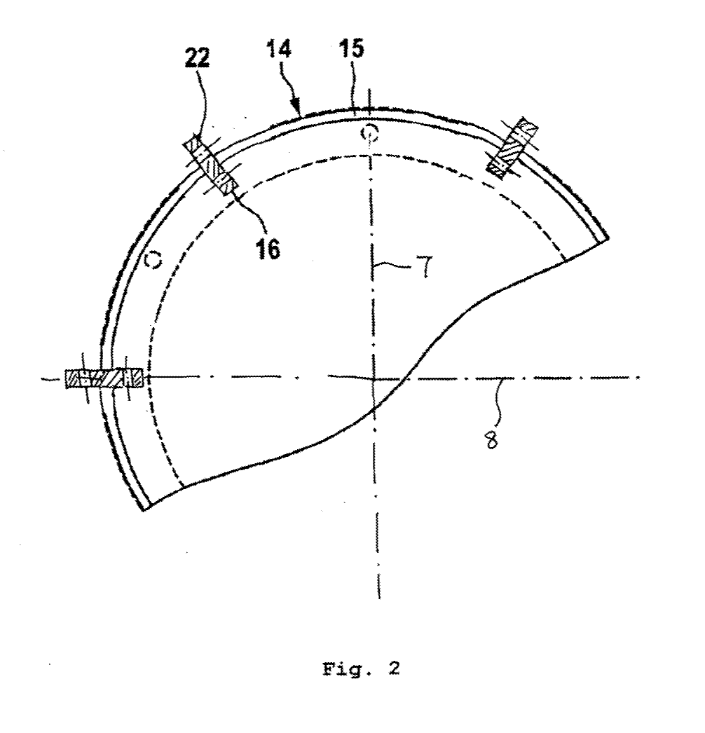

FIGS. 1-2 illustrate a first embodiment of the present application.

FIG. 1 illustrates a side view of an exposed dual clutch 6. The dual clutch 6 is provided between a combustion engine 3 on the left and a gearbox 5 on the right. The combustion engine 3 and the gearbox 5 are not shown in FIG. 1.

The combustion engine 3 is connected to the dual clutch 6 via a crankshaft 4, which is partially shown in the FIG. 1. The gearbox 5 is connected to the dual clutch 6 via an inner input shaft 35 and an outer input shaft 36. The inner shaft 35 and the outer shaft 36 are connected to two clutches 31, 42 respectively. The inner clutch 31 is connected to the inner input shaft 35 and the outer clutch 42 is connected to the outer input shaft 36. Longitudinal directions of crankshaft 4, the dual clutch 6, the inner input shaft 35 and the outer input shaft are aligned to an axis 2, which serves as the common rotational axis of the crankshaft 4, of the dual clutch 6 and of the input shafts 35, 36.

The crankshaft 4 of the combustion machine 3 is tightly connected to a flywheel 11 of the dual clutch 6 via screw connections. Only two of the screw connections 9, 10 are visible in FIG. 1. There are six such screw connections available.

The flywheel 11 comprises an annular disk extending in radial direction of the rotation axis 2. The flywheel 11 has an outer edge that is bent uniformly towards the gearbox 5. A sprocket 12 is attached onto the bent outer edge.

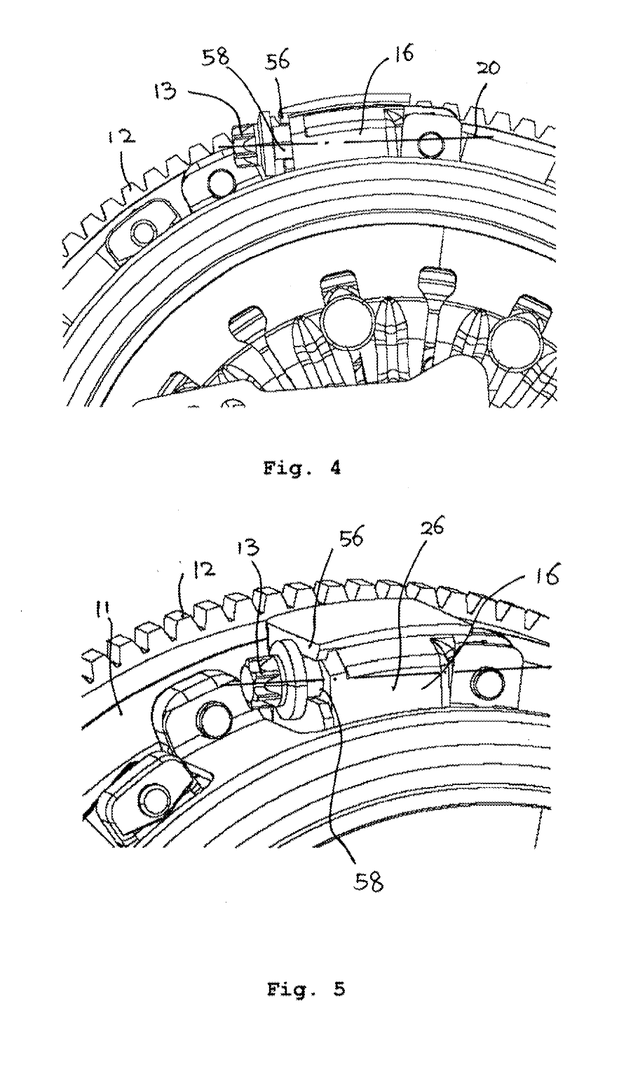

The flywheel 11 is attached to an intermediate pressure plate 26 of the dual clutch 6 via a cover 14 in the longitudinal direction of the crankshaft 4. The cover 14 comprises an intermediate ring body 15, in the form of a barrel, which resembles a circular cylinder. At the combustion engine side, the intermediate ring body 15 comprises an attachment lug 16 extending from a peripheral edge of the intermediate ring body 15. The attachment lug 16 comprises a threaded hole 17 that opens in the direction of rotation. Correspondingly, the flywheel 11 comprises a pocket 52 that receives the attachment lug 16. The pocket 52 comprises an end plate 54 for joining the attachment lug 16 with a cap screw 13. The cap screw 13 connects the attachment lug 16 to the flywheel 11. Details of the screw connection are shown in FIGS. 4-5. A longitudinal direction of the cap screw 13 is in a lateral direction with respect to the longitudinal axis 2. In particular, the longitudinal direction of the cap screw 13 is perpendicular to the longitudinal axis 2 and lies in a rotational plane of the dual clutch 6. The rotational plane is perpendicular to the rotation axis 2. There is provided a spring washer 18 on the attachment lug 16 such that the cap screw 13 can be securely tightened. Further details of the screw connection can be found in FIGS. 4-5.

There are six attachment lugs evenly distributed around the peripheral of the flywheel 11. Each of these six attachment lugs is bolted to recesses on the flywheel 11 respectively. Spring washers are also provided onto the six attachment lugs respectively.

On the right side of the intermediate ring body 15 towards the gearbox 5, there is further shown an attachment lug 22. The attachment lug 22 comprises a circular through hole that opens in the direction of dual clutch rotation. Correspondingly, there is a recess provided on the intermediate pressure plate 26 for receiving the attachment lug 22. In the recess, the intermediate ring body 15 comprises a threaded hole such that a cap screw 13 joins the attachment lug 22 to the intermediate pressure plate 26 at the threaded hole. A longitudinal direction of the cap screw 13 is in a lateral direction with respect to the longitudinal axis 2. In particular, the longitudinal direction of the cap screw 13 is perpendicular to the longitudinal axis 2.

Inside the intermediate ring body 15, friction pads 29 are provided between the intermediate pressure plate 26 and a pressure plate 28 on the left. The friction pads 29 can be forced against the intermediate pressure plate 26 or the pressure plate 28 in the axial direction for engaging and disengaging the intermediate pressure plate 26. The friction pads 29 are provided on two opposite sides of the inner clutch disk 31. The inner clutch disk 31 is non-rotatably connected to the inner input shaft 35, which is in the form of a solid shaft.

The inner input shaft 35 is disposed inside the outer input shaft 36. Both input shafts 35, 36 shares the common rotational axis 2. The inner input shaft 35 protrudes outside the outer input shaft 36 at a left end.

A hub part 38 is provided at a left end on a splined portion of the outer input shaft 36. The hub part 38 is connected to outer input shaft 36 via a roller bearing 37. The intermediate pressure plate 26 is mounted on the hub part 38 such that the hub part 38 is able to rotate around the input shafts 35, 36 freely. Friction pads 40 are further provided between the intermediate pressure plate 26 and a pressure plate 39. The friction pads 40 are attached onto a second clutch disk 42 on opposite sides of the second clutch disk 42. The second clutch disk 42 is also mounted onto the outer input shaft 36 on a splined portion of a hub part 43.

The dual clutch 6 comprises a clutch lid 44. The clutch lid 44 is attached to both the pressure plates 28, 39 in the axial direction. Furthermore, the intermediate pressure plate 26 is attached to the clutch lid 44. The dual clutch 6 is actuated via actuation means 46, 47 that interact with actuation levers 48, 49.

FIG. 2 illustrates a front view of the detached cover 14. The cover 14 comprises six attachment lugs radially extending from its peripheral. In the front view, there are only three attachment lugs shown. There is also shown a horizontal axis 8 and a vertical axis 7 on the detached cover 14. The horizontal axis 8 and the vertical axis 7 are perpendicular to each other. The intersection of the horizontal axis 8 and a vertical axis 7 is aligned to the longitudinal axis of the cover 14. Longitudinal axes of the attachment lugs are depicted. The longitudinal axes of the attachment lugs follow the direction of rotation of the flywheel 11. The six attachment lugs are evenly distributed such that there is an angle of 60° between every two angularly neighbouring attachment lugs.

The screws 13 connect the cover 14 to the flywheel 11 and the intermediate pressure plate 26 laterally with respect to the rotation axis 2 of the dual clutch 6. This arrangement is advantageous in providing a compact dual clutch. In practise, the dual clutch 6 is enclosed inside a casing that is closely fitted to the dual clutch 6. Little clearance is provided between the casing and the exterior of the dual clutch 6 because the dual clutch has to be made as compact as possible. Since the longitudinal axes of the screws 13 are parallel to the rotational direction of the dual clutch 6, larger screws can be provided because those larger screws can be accessed in radial directions of the dual clutch 6. Openings can be provided on the casing such that the larger screws are more accessible in the radial directions.

In operation, the lateral screw 13 connections almost do not generate noise. In maintenance, magnetic tools for accessing the screws 13 can avoid dropping the screws 13 inside the casing. When an accessed screw is rotated at the bottom of the dual clutch 6, parts of the screw connection will drop out of the casing due gravity, which is desired for taking the screw out of the casing.

Additionally, due to lateral screw connections, the gearbox 5 and the combustion engine 3 can be assembled by force fit and form fit.

The closely fitted casing demands smaller screws that may reduce reliability of the screw connections. Furthermore, due to the constrain of the closely fitted casing, the screw has to be reduced in threaded length. Once the screws are provided in the lateral direction, longer screws with larger heads become acceptable for a compact dual clutch.

The cover 14 is connected to the flywheel 11 via screws 13. Longitudinal axes of the screws 13 follow the direction of rotation of the dual clutch 6. In other words, the longitudinal axes of the screws are lateral to the rotational axis of the dual clutch. The dual clutch 6 is an example of a clutch assembly. The clutch assembly can be a single clutch or a dual clutch.

The end plate provides a supporting base to the socket screw for holding the cover and the flywheel together. There are six end plates around the circumference of the flywheel so that the flywheel is evenly tightened to the cover at its circular edge. The end plates prevent relative rotational movement between the flywheel and the cover.

Six pockets on the flywheel enclose six attachment lugs respectively. The pockets hold the attachment lugs securely that no lateral movement of the cover is permitted. The closely fitted pocket reduces lateral vibration of the cover as well.

The sprocket 12 is also known as a starter ring or a ring gear. The fastener is a hardware device that mechanically joins or affixes two or more objects together. Examples of the fastener comprise bolt, screw, cap screw, stud, button, clamp, cramp, clasp, nail, peg, pin, etc.

Alternatively, the flywheel 11 can comprise stoppers that prevent the cover's axial movement in the tightened position. The stoppers do not obstruct assembling the attachment lugs to the pockets when attaching the cover to the flywheel in the axial direction of the dual clutch. For example, the stopper can be in the form of a screw that is coupled to a threaded through hole on the side of the pocket. The screw is screwed into the threaded through hole in a radial direction towards centre of the flywheel 11. The screw is tightened against an indent on the attachment lug 16 after the socket screw is in tightened position. Further alternatives of the stoppers can be readily envisaged. For example, there can be fins on the cover that matches with the slots on the flywheel for preventing the cover's axial movement with respect to the flywheel. The stoppers can be spring-loaded that automatically locks into sockets on one of the flywheel and the cover after fully inserting the attachment lugs into the pockets. The spring-loaded stoppers can be push released for disassembling the cover from the flywheel.

A method of assembling the cover 14 to the flywheel 11 comprises several steps. Firstly, the socket screws are partially screwed into the attachment lugs 16 of the cover 14, which is known as pre-mount. The cover with the socket screws is then attached to the flywheel such that the attachment lugs are inserted into their respective pockets of the flywheel 11. The flanges and the screw heads of the socket screws are outside pockets. When the shanks of the socket screws are fully inserted into the slots of the end plates, the socket screws are tightened such that the cover and the flywheel are joined together. The method of assembling may further comprises a step of providing a stopper for blocking axial movement of the cover. The axial movement is a shift of position following the direction of the longitudinal axis.

A method of disassembling the cover 14 from the flywheel 11 also comprises several steps. Initially, the socket screws are loosened such that the cover can be rotated around the longitudinal axis of the dual clutch slightly. Afterwards, the cover with the socket screws is pulled out in the longitudinal direction of the dual clutch until the attachment lugs fully depart from the pockets of the flywheel 11. The method of disassembling may further comprises a step of removing the stopper for freeing the axial movement of the cover, which happens before loosening the socket screws.

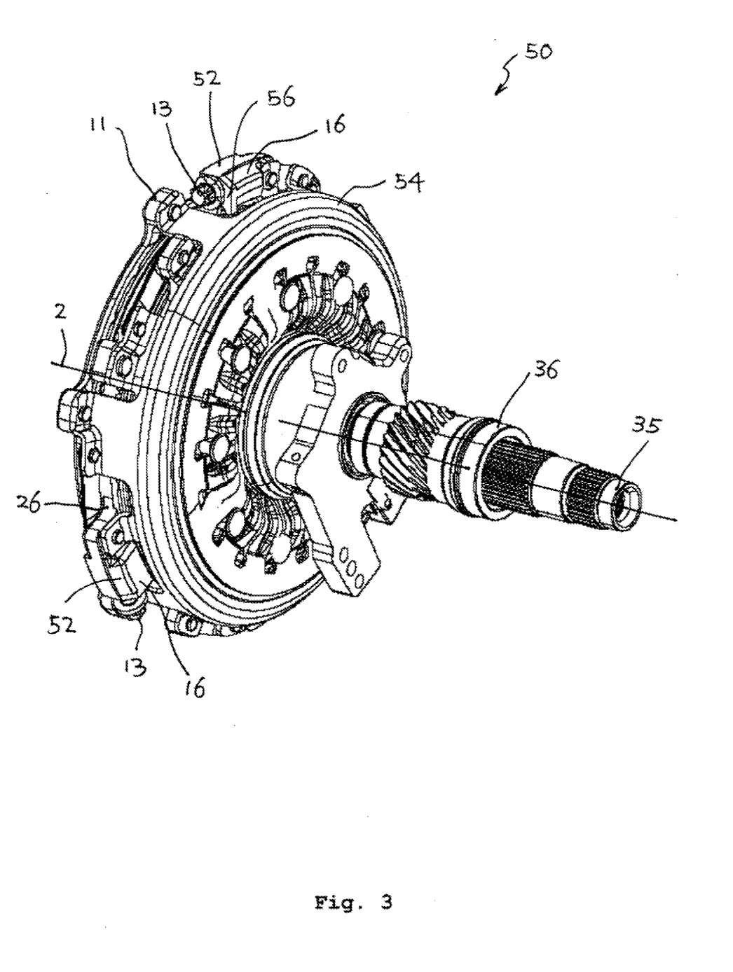

FIGS. 3-6 illustrate a second embodiment of the present application. The second embodiment comprises parts that are similar to the first embodiment of FIGS. 1-2. The similar parts possess same reference part numbers. Relevant descriptions of the similar parts are therefore incorporated by reference.

FIG. 3 illustrates another dual clutch 50 using pre-mounted cap screws 13. The dual clutch comprises a flywheel 11, an intermediate pressure plate 26 and a housing 54 that are connected together. The dual clutch 50 is configured to rotate around its longitudinal axis 2. The housing 54 encloses the intermediate pressure plate 26. The housing 54 further comprise side openings that permit three attachment lugs 16 of the intermediate pressure plate 26 protruding outside the housing 52. Each of the three attachment lugs 16 extend from a circumference of the intermediate pressure plate 26 and are enclosed by pockets 52 on the flywheel 11 at corresponding places respectively. In the longitudinal direction towards right, the dual clutch 50 is connected to an inner shaft 35 and an outer shaft 36. Pressure plates 28, 39 are non-rotatably connected to the input shafts 35, 36 respectively inside the housing 54, which are not visible in FIG. 3.

The intermediate pressure plate 26 comprises the three attachment lugs 16 distributed around its edge evenly. There is an angle of 120° between every two angularly neighbouring attachment lugs 16. Each of those pockets 52 opens towards the input shafts 35, 36. Details of the pockets 52 are better seen in FIG. 4.

FIG. 4 illustrates an enlarged portion of the other dual clutch 50 viewing in a longitudinal direction of the other dual clutch 50. The cap screw 13 is shown in a pre-mounted position on the housing 54. The screw 13 has not been fully tightened into a threaded hole 17 in the attachment lug 16. There is a gap provided between the flange of the screw 13 and the attachment lug 16. FIG. 4 also shows a longitudinal axis of the screw 20. The longitudinal axis of the screw 20 is aligned top the longitudinal axis of the attachment lug 16, the pocket 52 and the slot 58. The longitudinal axis of the screw and the attachment lug 20 is perpendicular to the longitudinal axis of the dual clutch 50.

The pocket 52 comprises two sides and opens at the side towards the input shafts 35, 36. The pocket 52 comprises an end plate 56 at its left end that matches the left end of the attachment lug 16. The end plate 56 also comprises a slot that opens towards the input shafts 35, 36 and parallel to the longitudinal axis 2. The shank of the screw 13 is fully inserted into the slot 58, while the flange and the screw head are outside the pocket 52. The intermediate pressure plate 26 is assembled onto the flywheel 11 from the longitudinal axis 2 towards the engine 3.

FIG. 5 illustrates the enlarge portion of the other dual clutch 50. The pre-mounted screw 13 is seen from another angle. In FIG. 5, the screw 13 is partially screwed into the attachment lug 16, which is known as pre-mounted. The intermediate pressure plate 26 is contiguous to the flywheel 11 and the screw 13 is inserted into the slot 58 of the pocket 52 on the flywheel 11.

The pre-mounted screw 13 is a flanged cap screw that has the screw head, the flange and the threaded shank. The cap screw 13 is also known as a Torx external cap screw with six lobes. The screw head is star-shaped with six rounded points. The flange extends from a base of the screw head laterally in the form of a disc. The threaded shank is further extended from the flange in the longitudinal direction of the cap screw.

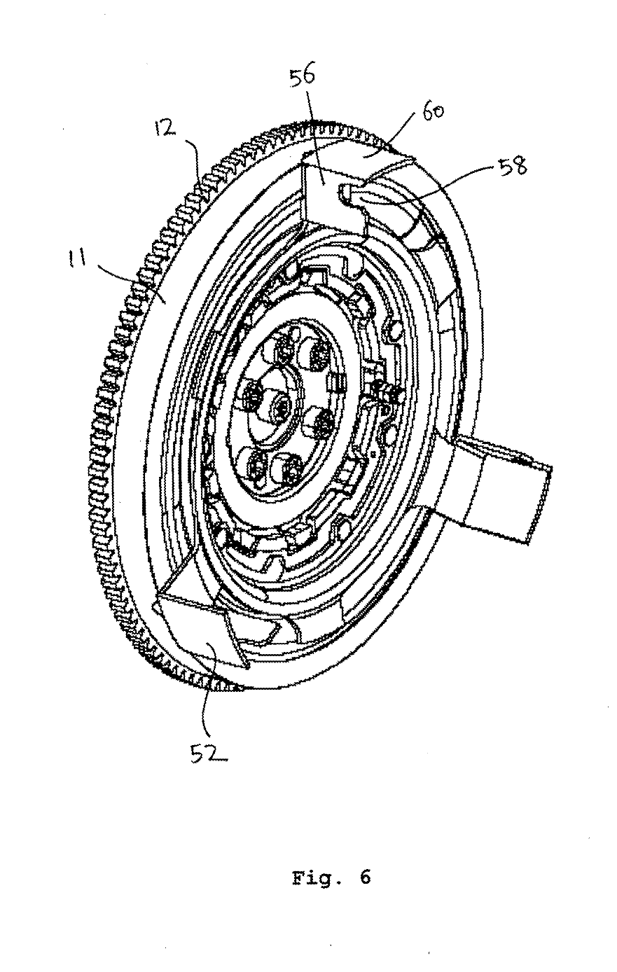

FIG. 6 illustrates the flywheel 11 of the other dual clutch 50 for assembling using pre-mounted cap screws 13. There are three pockets 52 distributed around the circumference of the flywheel 11. Each of the pockets 52 is formed by two plates, which are the end plate 56 and a top plate 60. The slot 58 opens the end plate 56 in a direction parallel to the longitudinal axis 2 of the dual clutch 50. The top plate 60 joins to the end plate 56 at an end. A side profile of the top plate 60 follows a circular curvature of the dual clutch 50.

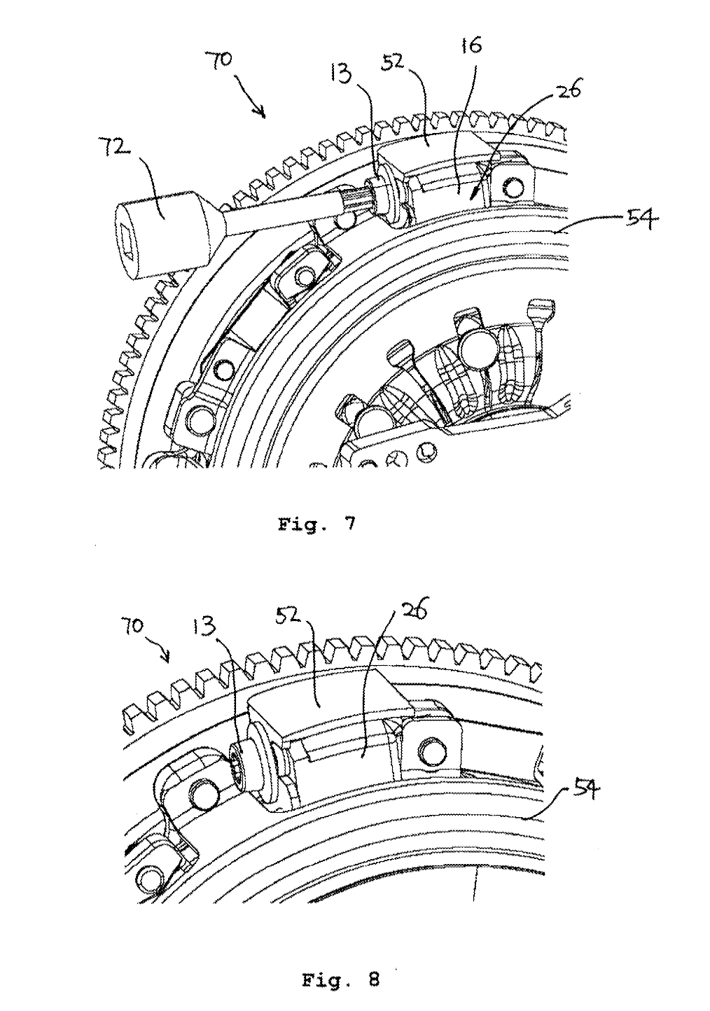

FIGS. 7-8 illustrate a third embodiment of the present application. The third embodiment comprises parts that are similar to the first and the second embodiments. The similar parts possess same reference part numbers. Relevant descriptions of the similar parts are therefore incorporated by reference. In the third embodiment, the cap screws 13 are replaced by socket screws.

FIG. 7 illustrates a pre-mounted socket screw 13 of a further dual clutch 70. The dual clutch 70 comprises a flywheel at the back and a housing 52 in the front. An attachment lug 16 extends from a circumference of an intermediate pressure plate 26 and protrudes outside an opening of the housing 52. The attachment lug 16 is fully inserted into a pocket 52 on the flywheel 11 that a shank of the socket screw 13 resides inside a slot 58 of the pocket 52.

A screwdriver 72 is shown connected to the socket screw 13 such that ahead of the screwdriver is inserted into a socket of the socket screw 13. The screwdriver 72 rotates clockwise for tightening the socket screw 13 such that the flywheel 11 and the intermediate pressure plate 26 are joined together.

FIG. 8 illustrates the tightened pre-mounted socket screw 13. The flange of the socket screw 13 is pushed against the end plate 56 of the pocket 52. The attachment lugs 16 of the intermediate pressure plate 26 are also pushed against the flywheel 11 in the longitudinal direction of the dual clutch 70.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practise. Thus, the scope of the embodiments should be determined by the claims and their equivalents, rather than by the examples given.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A disc component of a clutch assembly comprising:
a pre-mounted fastener configured to fasten the disc component to a second disc component from a later side of the disc component of the clutch assembly; and
a mounting structure opening in a longitudinal direction of the disc component, the mounting structure being configured to receive the pre-mounted fastener on the second disc component of the clutch assembly from the longitudinal direction.

2. The disc component according to claim 1, wherein
the mounting structure comprises a lateral slot that opens in a direction substantially parallel to a longitudinal axis of the clutch assembly.

3. The disc component according to claim 1, wherein
the pre-mounted fastener comprises a screw.

4. The disc component according to claim 1, wherein
the disc component comprises a flywheel configured for a lateral fastening.

5. The disc component according to claim 1, wherein
the disc component comprises a pressure plate configured for lateral fastening to the second disc component.

6. The disc component according to claim 1, wherein
a second longitudinal axis of the pre-mounted fastener is in a rotation plane of the disc component, the rotation plane substantially perpendicular to the longitudinal axis of the disc component.

7. The disc component according to claim 6, wherein
the second longitudinal axis of the pre-mounted fastener is substantially perpendicular to a direction of a central fugal force of the pre-mounted screw when the disc component rotates around the longitudinal axis of the disc component.

8. (canceled)

9. A clutch assembly, comprising:
a casing; and
a disc component fitted to the casing, the disc component comprising:
a pre-mounted fastener configured to fasten the disc component to a second disc component from a later side of the disc component of the clutch assembly; and
a mounting structure opening in a longitudinal direction of the disc component, the mounting structure being configured to receive the pre-mounted fastener on the second disc component of the clutch assembly from the longitudinal direction.

10. The clutch assembly according to claim 9, wherein
the casing comprises a plurality of openings for accessing the pre-mounted fastener from an exterior of the clutch assembly.

11. The clutch assembly according to claim 9, further comprising
a stopper configured for preventing the disc component moving away from the second disc component of the clutch assembly.

12. (canceled)

13. (canceled)

14. A method of assembling a clutch assembly comprising the steps of
pre-mounting a fastener onto a disc component of the clutch assembly;
installing the disc component with the pre-mounted fasteners from a longitudinal direction of the clutch assembly; and
fastening the pre-mounted fastener from a lateral side of the clutch assembly.

15. A method of disassembling a clutch assembly comprising the step of
partially loosening fastener on a disc component of the clutch assembly; and
removing the disc component with the fastener in a longitudinal direction of the clutch assembly.
